(19) United States
(12) Patent Application Publication
(10) Pub. No.: US 2001/0002364 A1
(43) Pub. Date: May 31, 2001

(54) Procedure and system for setting up a telecommunication connection

(75) Inventor: Pasi Lahtinen, London (GB)

Correspondence Address: Lance J. Lieberman, Esq., COHEN, PONTANI, LIEBERMAN & PAVANE, Suite 1210, 551 Fifth Avenue, New York, NY, 10176, US

(73) Assignee: Sonera Oyj

(21) Appl. No.: 09/735,211

(22) Filed: Dec. 12, 2000

(30) Foreign Application Priority Data
Jun. 12, 1998 (FI) 981369
Jun. 11, 1999 (FI) PCT/FI99/00514

(51) Int. Cl. H04M 11/00

(52) U.S. Cl. 455/445; 455/406

(57) ABSTRACT

A method and system for setting up a call between a calling subscriber located in a first country (C1) and a called subscriber located in a second country (C2), using a telecommunication system that comprises telecommunication terminals of the calling and called subscribers, a telecommunication network, and a telecommunication server. The calling subscriber sends a call setup message to the telecommunication server in the telecommunication network, the telecommunication server sets up one telecommunication connection to the calling subscriber and another telecommunication connection to the called subscriber, and the then connects the two telecommunication connections to establish a telecommunication connection from the called subscriber to the calling subscriber.

### BACKGROUND OF THE INVENTION

1. Field of the Invention

The present invention relates to a system and method for setting up a telecommunication connection or call between telecommunication subscribers located in two different countries.

2. Description of Related Art

It is well known that the calling prices charged by telephone and telecommunication system operators in different countries vary considerably. System operator pricing policies often lead to a situation in which a call between two countries is notably less expensive if set up or established in one, rather than the other or reverse, direction. In such cases it is less costly to make a call, for example, from Finland to Central Europe than from Central Europe to Finland. As a result, it is not uncommon for one telecommunication subscriber wishing to call a second subscriber in a different country to first make a brief call to the other, e.g. in Finland, and ask the called party to immediately call back. Another common practice is to call a telephone order service provided by the telecommunication operator in which a person answering the call calls back the A-party (i.e. the calling party) and then connects the call to the terminal or telephone number of the intended B-party (i.e. the called party). Still other known methods for avoiding this problem of unequal, direction-dependent charges for inter-country calls include:

phone cards by means of which the A-party can call an Automatic Telephone service System (ATS) and, using tone frequency selections, request or order a callback to the B-party's number;

automated CallBack machines, which automatically call back the A-party and to which the A-party provides billing information and the B-party's telephone number; and

Telecard service, in which a call from outside of Finland to a number beginning with 0800 or another set of dedicated digits is connected directly to a Finnish (or other country) operator, and like services provided by telecommunication system operators in other countries.

Each of the aforementioned methods has certain drawbacks. In the Telecard service, for example, calls are charged to the B-party, the initial charge is high, and the system operator must acquire an 0800 number in each country in which the service is to be provided. Other problems arise because calling line identification cannot always be successfully carried out in the case on calls that originate from abroad, changing passwords are needed, or the desired called party's number or other numerical information must be input via tone frequency selection (e.g. ATS). In addition, in automated systems and telephone order services, the call is set up by first calling the number of the system or service, thus increasing the total costs of the call. That is, it is only after this initial call that a less expensive return call to the A-party can be established.

### SUMMARY OF THE INVENTION

It is accordingly the desideratum of the invention to provide a system and method for overcoming the drawbacks and deficiencies of the prior art, as for example hereinabove discussed and described.

Toward that end, the system of the present invention comprises a telecommunication terminal, as for example a GSM telephone, of a calling or A-party or subscriber, a telecommunication terminal, as for example a mobile station or a wired-network telephone, of a called or B-party or subscriber, and a telecommunication server that includes means for handling calls and messages.

In the method or procedure of the invention, a telephone connection is set up between an A-party located in a first country C1 and a B-party located in another or second country C2. More particularly, the A-party sends, from his or her telecommunication terminal to a telecommunication server connected to the mobile subscriber network, a call setup message. From the received call setup message, the telecommunication server identifies the B-party's telephone number. The telecommunication server then sets up a first call to the A-party and another or second call to the B-party, and connects the two (i.e. first and second) calls so that a communication connection or call is established from the B-party to the A-party. In further accordance with the inventive method, the telecommunication server identifies the A-party's subscription and directs the charges for the call to that A-party subscription. The call setup message that is sent from the telecommunication terminal of the A-party to the telecommunication server is, by way of preferred example, a Short Message Service (SMS) message or an Unstructured Supplementary Service Data (USSD) message.

The method and system of the invention make it possible to achieve a rapid and ready change and selection of call setup direction. For a call established in accordance with the present invention, the only expenses are those arising from sending of the initial saetup message and from the actual call. In particular, the inventive method and system allow for easy input of the called number which can be entered directly on a GSM telephone before setup of the actual call, instead for example via tone frequency selection during the call. In addition, the identity of the A-subscription is reliably determined with certainty and ease, thus allowing the call to be charged to that subscription. In the inventive system, user identification is as safe and secure as in the GSM system at present.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1 is a schematic block diagram of a system in accordance with the present invention;

FIG. 2 is a flow chart of the inventive method; and

FIG. 3 is a signaling diagram of a system in accordance with the invention.

### DETAILED DESCRIPTION OF THE CURRENTLY PREFERRED EMBODIMENTS

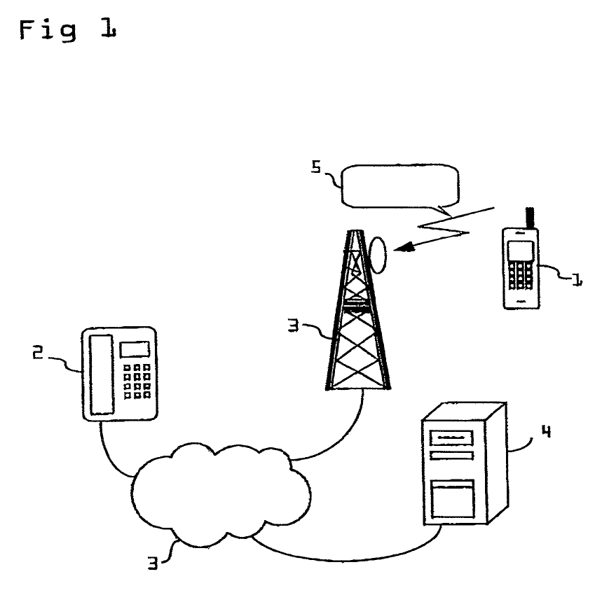

The inventive system as shown in FIG. 1 includes an A-party 's telecommunication terminal 1 (which may by way of example be a GSM telephone or a corresponding mobile station), a B-party's telecommunication terminal 2 (which may for example be a mobile station or a wired-network telephone), a mobile communication system 3, and a telecommunication server 4 connected to the communication system 3 and provided with means for handling messages and setting up or establishing calls and connections.

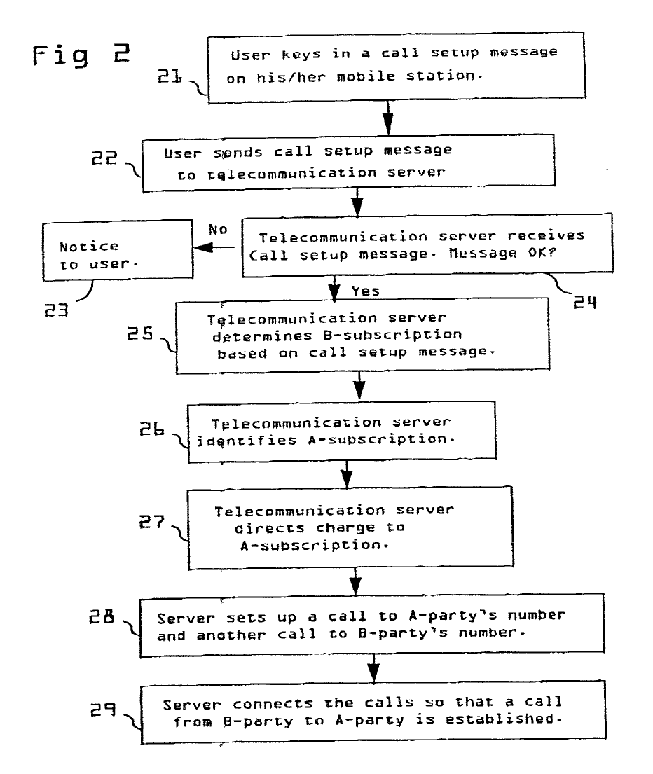

In accordance with the method of the invention, and with reference to FIG. 2, a calling or call-initiating or A-party inputs or keys, from the A-party's terminal or mobile station 1, a call setup message 5 (block 21). The call setup message 5 contains the telephone or terminal number of the called or target or B-party with whom a telephone or telecommunications connection is to be established. The A-party 1 sends (block 22) the call setup message 5 from his or her mobile station 2 to the telecommunication server 4. If the transmission is unsuccessful, then a corresponding notification is sent to the user at block 23. If, on the other hand, the transmission attempt is successful, then the telecommunication server 4 receives the call setup message 5 and determines, from the call setup message 5, the identity or number of the B-party (block 25). Next, at block 26, the telecommunication server 4 identifies the A-party's subscription and, at block 27, directs the charges for the call to that A-party subscription. The telecommunication server 4 then sets up one call to the A-party and another call to the B-party (block 28), and connects the two calls (block 29) to thereby establish a communication connection or call from the B-party to the A-party.

As should be apparent, in the practice of the inventive method the A-party's subscription can alternatively be identified before the B-party's subscription is determined from the call setup message 5.

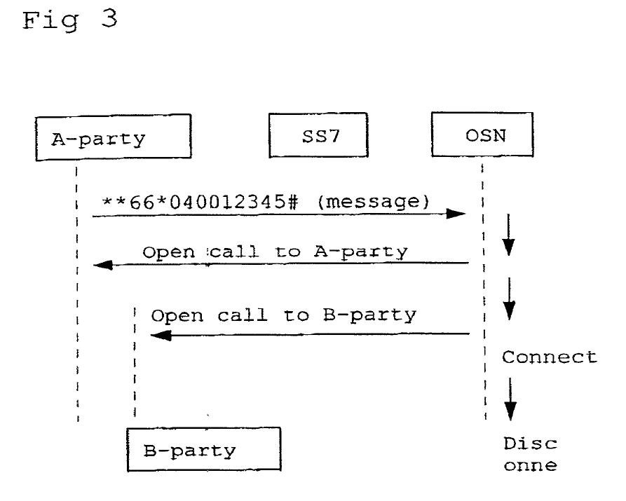

FIG. 3 depicts by way of example a signaling arrangement in accordance with the invention.. The A-party sends the call setup message 5 to an OSN telecommunication server 4 via the signaling channel of the telecommunication network 3. The actions required to identify the A-party and B-party are carried out in the OSN server, whereupon calls to the A-party and to the B-party are set up. The OSN server 4 connects the calls and, after receiving a call setdown request from the A-party or B-party, disconnects the call.

Thus, in the system shown by way of example in FIG. 1 the telecommunication server 4 may for example be an OSN (Open Service Node) telecommunication server. OSN is a system designed and implemented for the development and testing of intelligent networks and for the execution of service applications, and can be utilized in the control of wired telephone networks, mobile communication networks and wide-band networks. OSN is based on an open system that can be expanded via software, thereby permitting the addition of various telecommunication network components such as ATM (Asynchronous Transfer Mode) switches.

Moreover, in the system presented in FIG. 1 and/or in accordance with the invention the call setup message 5 may by way of preferred example be an Unstructured Supplementary Service Data (USSD) message. By utilizing USSD operations unstructured supplementary service data can be transmitted between a mobile station and a telecommunication network. The call setup message 5 can be transmitted using the CCITT common channel signaling standard SS7.

Thus, while there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for setting up a telecommunication connection between an A-party located in a first country and a B-party located in a second country using a switched telecommunication system that includes a switched telecommunication network comprising a digital mobile telecommunications network, a telecommunication terminal of the A-party and connected to the switched telecommunication network, a telecommunication terminal of the B-party and connected to the switched telecommunication network, and a telecommunication server connected to the switched telecommunication network and comprising means for handling messages and setting up telecommunication connections, comprising the steps of:
sending, from the A-party telecommunication terminal to the telecommunication server, a call setup message;
setting up, at the telecommunication server, a first telecommunication connection from the telecommunication server to the A-party telecommunication terminal;
setting up, at the telecommunication server based on the call setup message received from the A-party telecommunication terminal, a second telecommunication connection from the telecommunication server to the B-party telecommunication terminal; and
connecting together, at the telecommunication server, the first and second telecommunication connections to establish a telecommunication connection from the B-party telecommunication terminal to the A-party telecommunication terminal.

2. A method in accordance with claim 1, wherein the call setup message contains a telephone number of the B-party.

3. A method in accordance with claim 1, further comprising the steps of:
identifying, at the telecommunication server, a subscription of the A-party; and
directing, to the A-party subscription, call charges for the telecommunication connection from the B-party telecommunication terminal to the A-party telecommunication terminal.

4. A method in accordance with claim 1, wherein the call setup message comprises a USSD message.

5. A system for setting up a telecommunication connection between an A-party located in a first country and a B-party located in a second country using a switched telecommunication system that includes a switched telecommunication network comprising a digital mobile telecommunications network, a telecommunication terminal of the A-party and connected to the switched telecommunication network, and a telecommunication terminal of the B-party and connected to the switched telecommunication network, the system comprising:
a telecommunication server connected to the switched telecommunication network and operable for handling messages and setting up telecommunication connections, said server comprising means for identifying a subscription of the B-party from a call setup message received by said server from the A-party telecommunication terminal, means for setting up a first telecommunication connection from the server to the A-party telecommunication terminal and a second telecommunication connection from the server to the B-party telecommunication terminal based on the call setup message, and means for connecting the first and second telecommunication connections to establish a telecommunication connection from the B-party telecommunication terminal to the A-party telecommunication terminal.

6. A system in accordance with claim 5, further comprising means in the A-party telecommunication terminal for sending the call setup message from the A-party telecommunication terminal to said server.

7. A system in accordance with claim 6, where said means in the A-party telecommunication terminal comprises means for including a telephone number of the B-party in the call setup message.

8. A system in accordance with claim 5, wherein said server further comprises means for identifying a subscription of the A-party and for directing, to the identified A-party subscription, call charges for the telecommunication connection established from the B-party terminal to the A-party terminal.

9. A system in accordance with claim 5, wherein said server further comprises means for handling USSD messages.
